(19) United States
(12) Patent Application Publication
(10) Pub. No.: US 2024/0066948 A1
(43) Pub. Date: Feb. 29, 2024

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kazumi AONO, Nagoya-shi (JP); Hiroyasu HADANO, Toyota-shi (JP); Takaaki INOKUCHI, Nagoya-shi (JP)

(73) Assignee: TOYOTA JIDOSHA KABUSHIKI KAISHA, Toyota-shi (JP)

(21) Appl. No.: 18/448,413

(22) Filed: Aug. 11, 2023

(30) Foreign Application Priority Data
Aug. 25, 2022 (JP) 2022-134085

(51) Int. Cl. B60H 1/00

(52) U.S. Cl. CPC B60H 1/00771; B60H 1/00657

(57) ABSTRACT

There is provided a controller configured to perform: obtaining, in response to receiving a request to remotely operate an air conditioner in a vehicle, information about a place where the vehicle is parked; obtaining information about a time point; selecting an air conditioning mode in the vehicle based on the information about the place and the information about the time point; and transmitting to the vehicle a command to operate the air conditioning in the air conditioning mode thus selected.

### CROSS REFERENCE TO THE RELATED APPLICATION

This application claims the benefit of Japanese Patent Application No. 2022-134085, filed on Aug. 25, 2022, which is hereby incorporated by reference herein in its entirety.

### BACKGROUND

### Technical Field

The present disclosure relates to an information processing apparatus and an information processing method.

### Description of the Related Art

There has been known a technique in which, in remote air conditioning where an air conditioner is operated remotely to adjust the internal environment of a vehicle when a user is not in the vehicle, it is determined whether or not a temperature condition is satisfied based on at least one of the interior temperature, the exterior temperature, and the temperature of a predetermined part, of the vehicle, and the air conditioner is stopped after a predetermined period of time has elapsed since the temperature condition is determined to be satisfied (for example, Patent Literature 1).

### CITATION LIST

### Patent Literature

Patent Literature 1: Japanese Patent Application Laid-Open Publication No. 2018-122836

### SUMMARY

The object of the present disclosure is to operate remote air conditioning in an appropriate air conditioning mode.

One aspect of the present disclosure is directed to an information processing apparatus including a controller configured to perform:
obtaining, in response to receiving a request to remotely operate air conditioning in a vehicle, information about a place where the vehicle is parked;
obtaining information about a time point;
selecting an air conditioning mode for the vehicle based on the information about the place and the information about the time point; and
transmitting to the vehicle a command to operate the air conditioning in the air conditioning mode thus selected.

Another aspect of the present disclosure is directed to an information processing method for causing a computer to perform:
obtaining, in response to receiving a request to remotely operate air conditioning in a vehicle, information about a place where the vehicle is parked;
obtaining information about a time point;
selecting an air conditioning mode for the vehicle based on the information about the place and the information about the time point; and
transmitting to the vehicle a command to operate the air conditioning in the air conditioning mode thus selected.

In addition, a further aspect of the present disclosure is directed to a program for causing a computer to perform the above-described method, or a storage medium storing the program in a non-transitory manner.

According to the present disclosure, it is possible to operate remote air conditioning in an appropriate air conditioning mode.

### BRIEF DESCRIPTION OF THE DRAWINGS

FIG. 1 is a view illustrating a schematic configuration of a system according to a first embodiment;

FIG. 2 illustrates hardware configurations and functional configurations of a vehicle, a user terminal, and a server;

FIG. 3 is a diagram illustrating an example of a functional configuration of the server;

FIG. 4 is a view illustrating an example of a table configuration of a vehicle information DB according to the first embodiment;

FIG. 5 is a view illustrating a relationship among time point, parking place, and air conditioning mode;

FIG. 6 is a diagram illustrating an example of functional components of an ECU according to the embodiment;

FIG. 7 is a diagram illustrating a functional configuration of the user terminal;

FIG. 8 is a view illustrating an example of an image displayed when application software capable of performing remote air conditioning is activated;

FIG. 9 is a sequence diagram of the processing of the system as a whole according to the first embodiment;

FIG. 10 is a flowchart of the processing of remote air conditioning in the server according to the first embodiment;

FIG. 11 is a flowchart of the processing of remote air conditioning in the vehicle according to the first embodiment;

FIG. 12 is a view illustrating a relationship among time point, parking place, and air conditioning mode;

FIG. 13 is a sequence diagram of the processing of the system as a whole according to a second embodiment;

FIG. 14 is a flowchart of the processing of remote air conditioning in the server according to the second embodiment;

FIG. 15 is a view illustrating an example of an image displayed when application software capable of performing remote air conditioning is activated;

FIG. 16 is a time chart illustrating a temporal change of a fan rotational speed;

FIG. 17 is a flowchart of the processing of remote air conditioning in the server according to a third embodiment; and

FIG. 18 is a view illustrating a relationship among operation mode, time point, parking place, and air conditioning mode.

### DESCRIPTION OF THE EMBODIMENTS

An information processing apparatus, which is one aspect of the present disclosure, is provided with a controller which is configured to perform: obtaining, in response to receiving a request to remotely operate air conditioning in a vehicle, information about a place where the vehicle is parked; obtaining information about a time point; selecting an air conditioning mode in the vehicle based on the information about the place and the information about the time point; and transmitting to the vehicle a command to operate the air conditioning in the air conditioning mode thus selected. Remote air conditioning is, for example, air conditioning performed by a user from outside the vehicle via remote control, and is performed by the user transmitting a request to perform air conditioning from outside the vehicle using a user terminal. The request is transmitted to an external information processing apparatus that gives commands to the vehicle.

The information about the place where the vehicle is parked may include, for example, information that can determine whether or not the vehicle is parked in a garage, or whether or not the vehicle is parked at home. This information may be, for example, information about the position of the vehicle or information about the detection value of a sensor provided in the vehicle. The information about the place where the vehicle is parked is information that serves as an indicator of how much sound or noise it is safe to generate. In addition, the information about the time point may also include information about a time zone at the current time. Also, the information about the time point may be information from which it can be determined whether it is daytime or nighttime.

Here, it is considered that the tolerance to sound is lower in the nighttime than in the daytime. In other words, the surroundings become quieter at night, so the sound or noise generated by the operation of the air conditioning in the vehicle may be felt to be relatively loud, or even a small noise may bother people when they sleep at night. Also, the tolerance to sound varies depending on the place where the vehicle is parked. For example, in cases where the vehicle is parked in a garage at home, it is also considered that even if the air conditioning is operated remotely, there is no noise problem because there are no people in the vehicle. However, the sound of the engine or the operating sound of the air conditioning may be heard in the neighboring houses. Thus, there may be a risk of disturbing neighbors.

Therefore, if the air conditioning mode of the vehicle is selected based on the information about the place and the information about the time point, it is possible to select an air conditioning mode that produces less operating noise when the tolerance for noise is low. In this way, the temperature inside the vehicle can be adjusted while taking the problem of noise into consideration. Note that, as such an air conditioning mode, there can be mentioned, for example, a mode in which the sound generated is louder but the time required to adjust the temperature is shorter, or a mode in which the sound generated is quieter but the time required to adjust the temperature is longer.

The controller generates a command to operate remote air conditioning in the selected air conditioning mode, and transmits the command to the vehicle. Thus, the remote air conditioning is operated in the selected air conditioning mode. The remote air conditioning is to operate air conditioning by remote control to adjust the environment inside the vehicle when the user is not in the vehicle.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

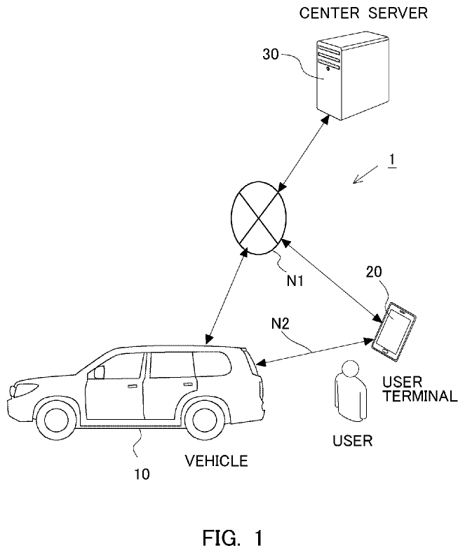

FIG. 1 is a view illustrating a schematic configuration of a system 1 according to a first embodiment. The system 1 is a system that can remotely operate an air conditioner of a vehicle 10 according to a request transmitted from a user terminal 20 to a server 30. Then, the server 30 selects a mode of air conditioning based on a place where the vehicle 10 is parked (hereinafter also referred to as the parking place) and a time point.

In the example of FIG. 1, the system 1 includes the vehicle 10, the user terminal 20 and the server 30. The user terminal 20 is a portable terminal that is owned or carried by a user. Also, the vehicle 10 is a vehicle associated with the user terminal 20. The vehicle 10, the user terminal 20 and the server 30 are mutually connected to one another by means of a network N1. Here, note that the network N1 is, for example, a worldwide public communication network such as the Internet or the like, and a WAN (Wide Area Network) or other communication networks may be adopted. Also, the network N1 may include a telephone communication network such as a mobile phone network or the like, and/or a wireless communication network such as Wi-Fi (registered trademark) or the like. Further, the vehicle 10 may be connected to the user terminal 20 via a network N2 including short-range wireless communication or the like. FIG. 1 illustrates one vehicle 10 by way of example, but there can be a plurality of vehicles 10. In addition, there can also be a plurality of users and user terminals 20, depending on the number of vehicles 10.

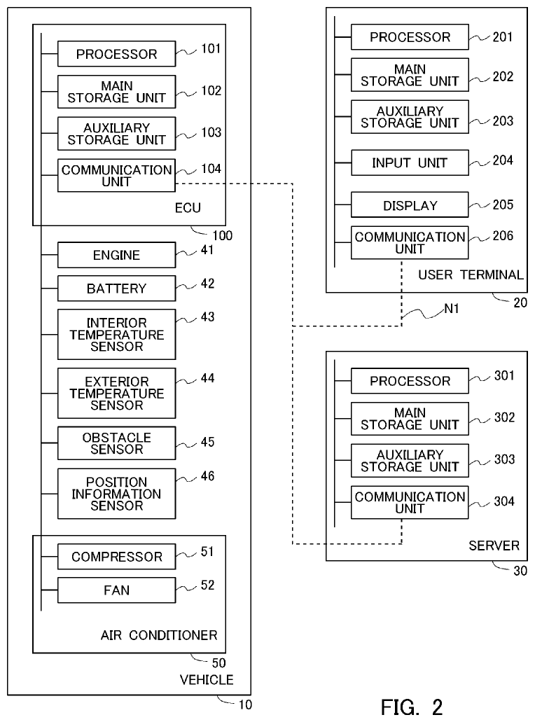

Hardware configurations and functional configurations of the vehicle 10, the user terminal 20 and the server 30 will be described based on FIG. 2. FIG. 2 is a block diagram schematically illustrating an example of a configuration of each of the vehicle 10, the user terminal 20 and the server 30, which together constitute the system 1 according to the present embodiment.

The server 30 has a configuration of a computer. The server 30 includes a processor 301, a main storage unit 302, an auxiliary storage unit 303, and a communication unit 304. These components are mutually connected to one another by means of a bus. Note that the processor 301 is an example of a controller. In addition, the main storage unit 302 and the auxiliary storage unit 303 are examples of a memory.

The processor 301 is a CPU (Central Processing Unit), a DSP (Digital Signal Processor), or the like. The processor 301 controls the server 30 thereby to perform various information processing operations. The main storage unit 302 is a RAM (Random Access Memory), a ROM (Read Only Memory), or the like. The auxiliary storage unit 303 is an EPROM (Erasable Programmable ROM), a hard disk drive (HDD), a removable medium, or the like. The auxiliary storage unit 303 stores an operating system (OS), various programs, various tables, and the like. The processor 301 loads a program stored in the auxiliary storage unit 303 into a work area of the main storage unit 302 and executes the program, so that each component or the like is controlled through the execution of the program. As a result, the server 30 realizes functions that match predetermined purposes. The main storage unit 302 and the auxiliary storage unit 303 are computer readable recording media. Here, note that the server 30 may be a single computer or a plurality of computers that cooperate with one another. In addition, the information stored in the auxiliary storage unit 303 may be stored in the main storage unit 302. Also, the information stored in the main storage unit 302 may be stored in the auxiliary storage unit 303.

The communication unit 304 is a means or unit that communicates with the vehicle 10 and the user terminal 20 via the network N1. The communication unit 304 is, for example, a LAN (Local Area Network) interface board, a wireless communication circuit for wireless communication, or the like. The LAN interface board or the wireless communication circuit is connected to the network N1.

Here, note that a series of processing executed by the sever 30 can be executed by hardware, but can also be executed by software.

Now, the user terminal 20 will be described. The user terminal 20 is, for example, a smart phone, a mobile phone, a tablet terminal, a personal information terminal, a wearable computer (such as a smart watch or the like), or a small computer such as a personal computer (PC). The user terminal 20 includes a processor 201, a main storage unit 202, an auxiliary storage unit 203, an input unit 204, a display 205, and a communication unit 206. These components are mutually connected to one another by means of a bus. The processor 201, the main storage unit 202 and the auxiliary storage unit 203 are the same as the processor 301, the main storage unit 302 and the auxiliary storage unit 303 of the server 30, respectively, and hence, the description thereof will be omitted.

The input unit 204 is a means or unit that receives an input operation performed by the user, and is, for example, a touch panel, a mouse, a keyboard, a push button, or the like. The display 205 is a means or unit that presents information to the user, and is, for example, an LCD (Liquid Crystal Display), an EL (Electroluminescence) panel, or the like. The input unit 204 and the display 205 may be configured as a single touch panel display.

The communication unit 206 is a communication means or unit for connecting the user terminal 20 to the network N1 or the network N2. The communication unit 206 is, for example, a circuit for communicating with other devices (e.g., the vehicle 10, the server 30 or the like) via the network N1 or the network N2 by making use of a mobile communication service (e.g., a telephone communication network such as 6G (6th Generation), 5G (5th Generation), 4G (4th Generation), 3G (3rd Generation), or LTE (Long Term Evolution)) or a wireless communication network such as Wi-Fi (registered trademark), Bluetooth (registered trademark) or the like.

Now, the vehicle 10 will be described. The vehicle 10 is equipped with an engine 41. The vehicle 10 includes an ECU 100, which is an electronic control unit, the engine 41, a battery 42, an interior temperature sensor 43, an exterior temperature sensor 44, an obstacle sensor 45, a position information sensor 46, and an air conditioner 50. These components are mutually connected to one another by means of a CAN bus, which is a bus of an in-vehicle network. Here, note that the present embodiment includes one ECU 100, but instead may include controllers corresponding to communication with the outside, control of the engine 41, and control of the air conditioner 50, respectively.

The ECU 100 has a configuration of a computer. The ECU 100 includes a processor 101, a main storage unit 102, an auxiliary storage unit 103, and a communication unit 104. These components are mutually connected to one another by means of a bus. The processor 101, the main storage unit 102, the auxiliary storage unit 103, and the communication unit 104 are the same as the processor 201, the main storage unit 202, the auxiliary storage unit 203, and the communication unit 206 of the user terminal 20, respectively, and hence, the description thereof will be omitted.

The engine 41 is, for example, a gasoline engine or a diesel engine, and its output can be used to charge the battery 42 or to drive the vehicle 10. In addition, cooling water for the engine 41 can also be used as a heat source for heating. In addition, a compressor 51 of the air conditioner 50 can be operated by operating the engine 41. The battery 42 is a secondary battery that can be repeatedly charged and discharged.

The interior temperature sensor 43 is a sensor that detects the temperature inside the vehicle 10 (vehicle interior temperature). The exterior temperature sensor 44 is a sensor that detects the temperature outside the vehicle 10 (vehicle exterior temperature). The obstacle sensor 45 is a sensor that detects obstacles in front of and behind the vehicle 10. As the obstacle sensor 45, there can be mentioned, for example, a stereo camera, a laser scanner, a LIDAR, a sonar, or a radar. The position information sensor 46 obtains position information (e.g., latitude and longitude) of the vehicle 10 at a predetermined cycle. The position information sensor 46 is, for example, a GPS (Global Positioning System) receiver unit, a wireless communication unit or the like. The information obtained by the position information sensor 46 is recorded, for example, in the auxiliary storage unit 103 or the like and transmitted to the server 30.

The air conditioner 50 is a device that adjusts the temperature inside the vehicle 10. The air conditioner 50 includes the compressor 51 and a fan 52. The compressor 51 is a device that is operated by power from the engine 41 to compress and liquefy a vaporized refrigerant. The compressor 51 includes, for example, a pulley connected to a crankshaft of the engine 41 through a belt. A magnet clutch, which is connected or engaged by passing electricity therethrough, is connected to the pulley, and the compressor 51 is operated by passing electricity to the magnet clutch when the engine 41 is operating. Here, note that the compressor 51 may be an electric compressor that is operated by the supply of electric power from the battery 42. In the compressor 51, as the rotational speed thereof becomes higher, the amount of refrigerant to be compressed per unit time increases, so that the vehicle interior temperature can be adjusted more quickly. The fan 52 is a device that blows air to a condenser that performs heat exchange between the refrigerant and the atmosphere. In the fan 52, the higher the rotational speed thereof, the more the amount of heat exchange per unit time increases, so that the vehicle interior temperature can be adjusted more quickly.

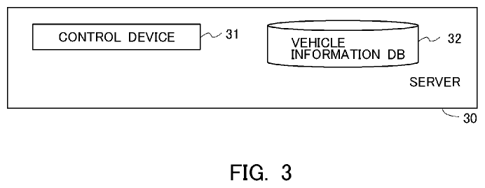

Then, the functions of the server 30 will be described. FIG. 3 is a diagram illustrating an example of a functional configuration of the server 30. The server 30 includes, as its functional components, a control device 31 and a vehicle information DB 32. The processor 301 of the server 30 executes the processing of the control device 31 by means of a computer program on the main storage unit 302.

The vehicle information DB 32 is, for example, a relational database that is built by a program of a database management system (DBMS) executed by the processor 301 to manage data stored in the auxiliary storage unit 303.

Upon receiving an air-conditioning request from the user terminal 20, the control device 31 transmits an air conditioning command to the vehicle 10. The air conditioning request is a request to remotely operate the air conditioner 50. The air conditioning command is a command or instruction for operating the air conditioner 50 of the vehicle 10 by remote control. The air conditioning command includes a command to start the engine 41 and to operate the air conditioner 50, as well as information about the air conditioning mode.

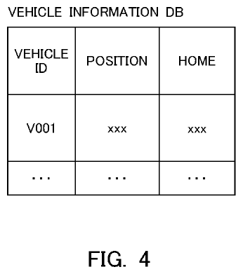

Here, FIG. 4 is a view illustrating an example of a table configuration of the vehicle information DB 32 according to the first embodiment. The vehicle information DB 32 includes fields for vehicle ID, position, and home. In the vehicle ID field, information that can identify each vehicle 10 (vehicle ID) is entered. In the position field, the position information transmitted from each vehicle 10 is entered. In the home field, information about the position of the home of each user is stored. The information about the position of each user's home includes information about the address or coordinates of the user's home associated with each vehicle 10. The information about the position of each user's home is registered in advance by each user via his or her user terminal 20. Here, note that the information about each home may be obtained by the control device 31 when each user registers for use from his or her user terminal 20 via application software that can perform remote air conditioning (hereinafter also simply referred to as “app”).

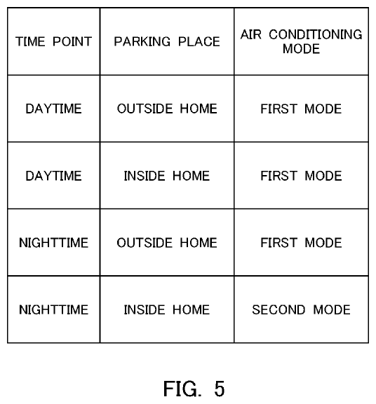

FIG. 5 is a view illustrating a relationship among time point, parking place, and air conditioning mode. This relationship is stored in the auxiliary storage unit 303. The time point is represented by daytime or nighttime. Note that the daytime is an example of a first time zone, and the nighttime is an example of a second time zone. The daytime may be, for example, a period of time from sunrise to sunset, or may be, for example, a period of time from 6 o'clock in the morning to 6 o'clock in the evening. The nighttime may be, for example, a period of time from sunset to sunrise, or may be, for example, a period of time from 6 o'clock in the evening to 6 o'clock in the morning. Also, as an alternative, for example, the daytime may be a period of time in which the average person is awake, and the nighttime may be a period of time in which the average person is sleeping. In addition, the time zones corresponding to the daytime and nighttime may be set by a user via his or her user terminal 20. Moreover, the nighttime may be a time zone including midnight (0:00 a.m.), and the daytime may be a time zone including noon (0:00 p.m.). As another alternative, the daytime may be a time zone in which the sound generated when the rotational speeds of the compressor 51 and the fan 52 of the air conditioner 50 are made the highest does not pose a problem, and the nighttime may be a time zone in which the sound generated when the rotational speeds of the compressor 51 and the fan 52 of the air conditioner 50 are made the highest does pose a problem.

The parking place is represented by “inside home” or “outside home”. The “inside home” indicates that the vehicle 10 is parked in the user's home premise. On the other hand, the “outside home” indicates that the vehicle 10 is parked in a place other than the user's home premise.

The air conditioning mode is represented by a first mode or a second mode. The first mode is a mode in which the upper limit values of the rotational speeds of the compressor 51 and the fan 52 are relatively high. The first mode may be an air conditioning mode in which the upper limit values of the rotational speeds of the compressor 51 and the fan 52 are made the highest. On the other hand, the second mode is a mode in which the upper limit values of the rotational speeds of the compressor 51 and the fan 52 are relatively low. The upper limit values of the rotational speeds of the compressor 51 and the fan 52 are lower in the second mode than in the first mode. Therefore, in the second mode, the volume of the sound becomes small, but the performance of the air conditioning becomes low, and hence, there is a concern that it may take a long time to adjust to a desired temperature, or that it may not be able to adjust to the desired temperature. However, if the air conditioner 50 is operated, the vehicle interior temperature can be adjusted to some extent. Therefore, in cases where priority is given to the suppression of noise, the second mode is performed to adjust the vehicle interior temperature while reducing the volume of the sound generated. On the other hand, in cases where priority is not given to the suppression of noise, the first mode is performed in order to give priority to increasing the performance of the air conditioning. As a result, the vehicle interior temperature can be quickly adjusted.

Here, in cases where the parking place is outside home or the time point is in the daytime, the first mode is selected because the enhancement of the performance of the air conditioning has priority over the suppression of noise. On the other hand, in cases where the parking place is inside home and the time point is in the nighttime, the second mode is selected because the suppression of noise has priority over the enhancement of the performance of the air conditioning.

The control device 31 determines whether or not the vehicle 10 is parked at the user's home, by comparing the position information of the vehicle 10 transmitted from the vehicle 10 with the information about the position of the user's home stored in the vehicle information DB 32. For example, in cases where the position of the vehicle 10 is within a predetermined range from the position of the user's home, the control device 31 determines that the vehicle 10 is parked at the user's home. The predetermined distance is a distance that may be considered to be inside home, and is, for example, a distance between 0 to several meters or several tens of meters.

The control device 31 selects the air conditioning mode based on the position information transmitted from the vehicle 10, the information about the position of the user's home stored in the vehicle information DB 32, and the relationship illustrated in FIG. 5, which is stored in the auxiliary storage unit 303. Note that the time point may be obtained by the server 30 via the network N1. In addition, as an alternative, the server 30 may have a function of a clock, and the time point may be obtained by making use of the function of the clock.

When selecting the air conditioning mode, the control device 31 transmits an air conditioning command to the vehicle 10. The air conditioning command includes a command to operate the engine 41, a command to operate the air conditioner 50, and a command to control the engine 41 and the air conditioner 50 according to the selected air conditioning mode.

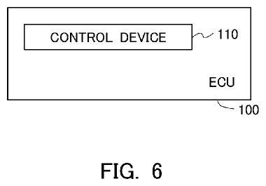

Next, a functional component of the ECU 100 of the vehicle 10 will be described. FIG. 6 is a diagram illustrating an example of the functional component of the ECU 100 according to the embodiment. The ECU 100 includes a control device 110 as its functional component. The processor 101 of the ECU 100 executes the processing of the control device 110 by means of a computer program on the main storage unit 102. However, any of the individual functional components or a part of the processing thereof may be implemented by a hardware circuit.

Upon receiving the air conditioning command transmitted from the server 30, the control device 110 operates the engine 41 and the air conditioner 50 based on this air conditioning command. Thus, the remote air conditioning of the vehicle 10 is started. When the remote air conditioning is performed, the engine 41 is operated to perform air conditioning. At this time, the air conditioning mode included in the air conditioning command is executed. The control device 110 sets the upper limit values of the rotational speeds of the compressor 51 and the fan 52 to be relatively high in cases where a command to perform the first mode is received from the server 30, and sets the upper limit values of the rotational speeds of the compressor 51 and the fan 52 to be lower than those in the first mode in cases where a command to perform the second mode is received from the server 30. Note that the upper limit values of the rotational speeds of the compressor 51 and the fan 52 corresponding to the first mode and the second mode may have been stored in the auxiliary storage unit 103 of the vehicle 10, or may be included in the air conditioning command received from the server 30. For example, the control device 110 may perform feedback control over the compressor 51 and the fan 52 based on the vehicle interior temperature so as not to exceed the upper limit values of the rotational speeds of the compressor 51 and the fan 52. Here, note that a known technique can be used for the control of the air conditioner 50.

In addition, the control device 110 transmits the position information obtained by the position information sensor 46 to the server 30 at predetermined time intervals.

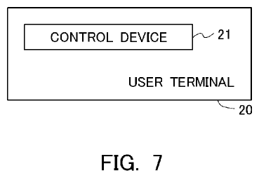

Now, the function of the user terminal 20 will be described. FIG. 7 is a diagram illustrating a functional configuration of the user terminal 20. The user terminal 20 includes a control device 21 as its functional component. The processor 201 of the user terminal 20 executes the processing of the control device 21 by a computer program on the main storage unit 202. However, a part of the processing of the control device 21 may be executed by a hardware circuit.

The control device 21 generates an air conditioning request in accordance with an input of a user, and transmits it to the server 30. When the user taps a predetermined icon displayed on the display 205, the control device 21 activates the app capable of executing remote air conditioning. Here, the app capable of performing remote air conditioning is installed in the user terminal 20, and when the user activates the app, an image for performing remote air conditioning is displayed.

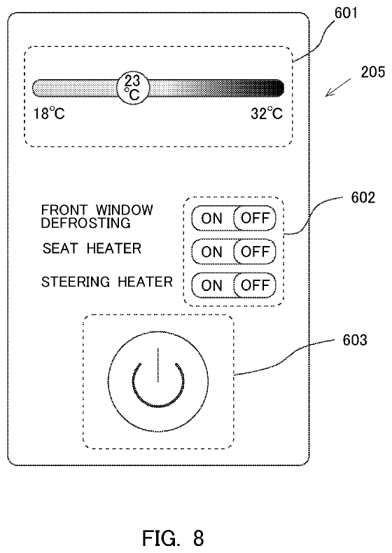

FIG. 8 is a view illustrating an example of an image displayed when the app capable of performing remote air conditioning is activated. Note that FIG. 8 is an example of a user interface for specifying air conditioning parameters illustrated. The illustrated user interface is configured to include a slider (reference numeral 601) for setting a temperature, a part (reference numeral 602) for specifying devices to be operated, a button (reference numeral 603) for transmitting a request, and the like.

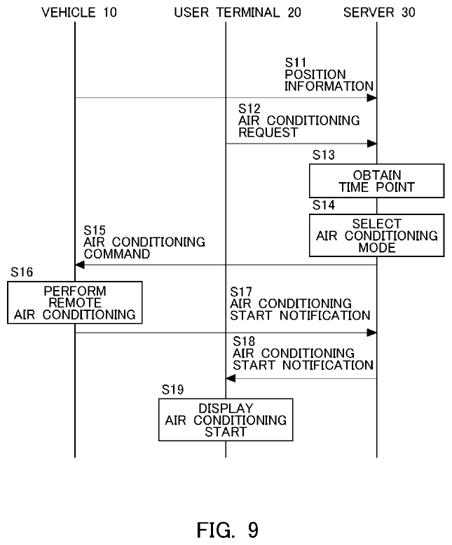

Then, the processing of the system 1 as a whole will be described. FIG. 9 is a sequence diagram of the processing of the system 1 as a whole according to the first embodiment. The vehicle 10 and the user terminal 20 illustrated in FIG. 9 have been associated with each other in advance and registered in the server 30. Note that the following description will be made on the assumption that the vehicle information DB 32 stores information about the home of each user.

Position information is transmitted from the vehicle 10 to the server 30 at predetermined time intervals (S11). The position information received by the server 30 is stored in the vehicle information DB 32. Note that, as an alternative, the position information may be obtained from the vehicle 10 by transmitting from the server 30 to the vehicle 10 a request to send the position information, triggered by the server 30 receiving the air conditioning request from the user terminal 20. In addition, when the user activates a predetermined app to perform an operation for starting remote air conditioning at the user terminal 20, an air conditioning request is generated at the user terminal 20 and transmitted to the server 30 (S12).

The server 30, which has received the air conditioning request, obtains information about a time point (S13). For example, the information about a time point is obtained from a server that provides time point information on the Internet. Further, the server 30 selects the air conditioning mode based on the position of the vehicle 10 and the time point (S14). The server 30 compares the position of the vehicle 10 with the position of the user's home stored in the vehicle information DB 32, and determines whether or not the vehicle 10 is parked at the user's home. In addition, it is determined whether the current time point corresponds to (i.e., is in) the daytime or nighttime. Then, the air conditioning mode is selected based on the relationship illustrated in FIG. 5, which is stored in the auxiliary storage unit 303.

The server 30, which has selected the air conditioning mode, generates an air conditioning command, which is a command for performing the remote air conditioning for the corresponding vehicle 10, and transmits it to the vehicle 10 (S15). This air conditioning command includes a command or instruction to perform the remote air conditioning in the selected air conditioning mode.

The control device 110 of the vehicle 10, which has received the air conditioning command, performs the remote air conditioning in the air conditioning mode designated by the air conditioning command (S16). When the remote air conditioning is performed, an air conditioning start notification is transmitted from the vehicle 10 to the server 30 (S17). The air conditioning start notification is a notification for notifying the user that the remote air conditioning has been started. The server 30 transmits the air conditioning start notification to the user terminal 20 (S18). In the user terminal 20 that has received the air conditioning start notification, an image indicating that the remote air conditioning has been started is displayed on the display 205 (S19). Thus, the user can know that the remote air conditioning has been started.

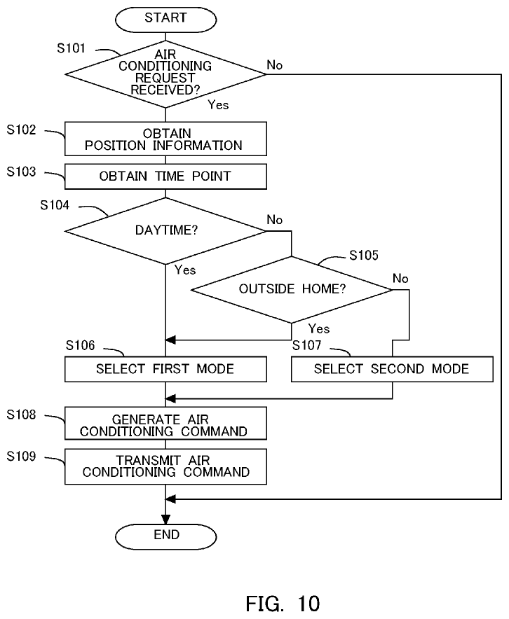

Next, the processing of the remote air conditioning in the server 30 will be described. FIG. 10 is a flowchart of the processing of the remote air conditioning in the server 30 according to the first embodiment. The processing illustrated in FIG. 10 is performed at predetermined time intervals at the server 30.

In step S101, the control device 31 determines whether or not an air conditioning request has been received from the user terminal 20. The air conditioning request includes information about a user ID, a vehicle ID, and the like. When an affirmative determination is made in step S101, the processing or routine proceeds to step S102, whereas when a negative determination is made, this routine is ended. In step S102, the control device 31 obtains, from the vehicle information DB 32, information about the position information of the vehicle 10 and the user's home. The control device 31 obtains information about the position of the vehicle 10 and the user's home from the vehicle information DB 32 based on the vehicle ID included in the air conditioning request.

In step S103, the control device 31 obtains information about a time point. For example, the control device 31 accesses a web server that provides information about time point via the communication unit 304 to obtain a time point at the current time. In step S104, the control device 31 determines, based on the obtained time point, whether or not the current time point corresponds to (i.e., is in) the daytime. The time points corresponding to the daytime have been stored in advance in the auxiliary storage unit 303. When an affirmative determination is made in step S104, the processing proceeds to step S106, whereas when a negative determination is made, the processing proceeds to step S105.

In step S105, the control device 31 determines whether or not the place where the vehicle 10 is parked is outside home. The control device 31 determines that the vehicle 10 is parked outside home, in cases where the position of the vehicle 10 is away from the position of the user's home by a predetermined distance or more. When an affirmative determination is made in step S105, the processing proceeds to step S106, whereas when a negative determination is made, the processing proceeds to step S107.

In step S106, the control device 31 selects the first mode as the air conditioning mode. On the other hand, in step S107, the control device 31 selects the second mode as the air conditioning mode. In step S108, the control device 31 generates an air conditioning command. The air conditioning command includes a command or instruction to activate the air conditioning by performing either the first mode or the second mode. In addition, it may also include a command to set the upper limit values of the rotational speeds of the compressor 51 and the fan 52 corresponding to each air conditioning mode. Further, the air conditioning command may also include information about a target temperature. Then, in step S109, the control device 31 transmits the air conditioning command to the vehicle 10.

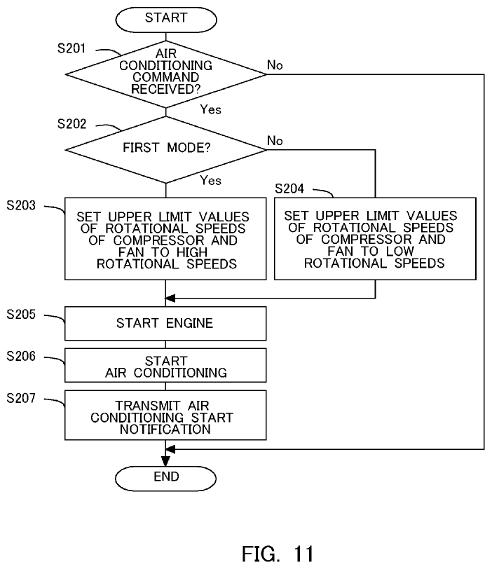

Next, the processing of the remote air conditioning in the vehicle 10 will be described. FIG. 11 is a flowchart of the processing of the remote air conditioning in the vehicle 10 according to the first embodiment. The processing illustrated in FIG. 11 is executed at predetermined time intervals in the ECU 100.

In step S201, the control device 110 determines whether an air conditioning command has been received from the server 30. The air conditioning command may include information about an air conditioning mode, or may include information about the upper limit values of the rotational speeds of the compressor 51 and the fan 52. When an affirmative determination is made in step S201, the processing or routine proceeds to step S202, whereas when a negative determination is made, this routine is ended.

In step S202, the control device 110 determines whether or not the air conditioning mode designated by the server 30 is the first mode. When an affirmative determination is made in step S202, the processing proceeds to step S203, whereas when a negative determination is made, the processing proceeds to step S204. In step S203, the control device 110 sets the upper limit values of the rotational speeds of the compressor 51 and the fan 52 to relatively high rotational speeds. The rotational speeds at this time may be included in the air conditioning command from the server 30, or may have been stored in the auxiliary storage unit 103. On the other hand, in step S204, the control device 110 sets the upper limit values of the rotational speeds of the compressor 51 and the fan 52 to relatively low rotational speeds. The upper limit values of the rotational speeds at this time are lower than the upper limit values of the rotational speeds set in step S203. In addition, the upper limit values of the rotational speeds at this time may be included in the air conditioning command from the server 30, or may have been stored in the auxiliary storage unit 103.

In step S205, the control device 110 starts the engine 41. Further, in step S206, the control device 110 starts the air conditioner 50 to start air conditioning. At this time, for example, feedback control is performed so that the vehicle interior temperature becomes the target temperature. Then, in step S207, the control device 110 transmits an air conditioning start notification to the server 30. The air conditioning start notification includes information indicating that the air conditioning has been started, and a vehicle ID, which is information for identifying the vehicle 10.

As described above, according to the present embodiment, the air conditioning mode is selected according to the place and the time point at which the vehicle 10 is parked, and hence, in a situation in which the influence of sound is significant, an appropriate air conditioning mode can be selected to reduce the volume of sound generated by the vehicle 10. Therefore, it is possible to suppress the annoyance to people in the vicinity of the vehicle due to the generation of sound. In addition, by operating the air conditioning within a range in which the problem of noise does not occur, the environment inside the vehicle can be brought close to an optimum environment. In situations where sound is not a problem, the environment inside the vehicle can be quickly adjusted by increasing the upper limit values of the rotational speeds of the compressor 51 and the fan 52.

### Second Embodiment

In the first embodiment, the position of the vehicle 10 is compared with the position of the user's home to determine whether or not the vehicle 10 is parked at the user's home. On the other hand, in a second embodiment, it is determined, based on the output of the obstacle sensor 45 provided in the vehicle 10, whether or not the vehicle 10 is parked in a garage. Here, for example, in cases where the vehicle 10 is parked in the garage of the user's home, the door of the garage may be closed. In this case, the vehicle 10 is surrounded by the walls of the garage and the door on all sides. Thus, the obstacle sensor 45 detects obstacles in front of and behind the vehicle 10. In this way, in cases where obstacles are detected in front of and behind the vehicle 10, the control device 31 determines that the vehicle 10 is parked in the garage. Here, note that in order to distinguish this from the case of parallel parking on a road or the like, for example, when obstacles are detected in all of diagonally forward right, diagonally forward left, diagonally rear right, and diagonally rear left, of the vehicle 10, it may be determined that the vehicle 10 is parked in the garage. In the second embodiment, it is not necessary to store the position information of the vehicle 10 and the information about the users' home in the vehicle information DB 32.

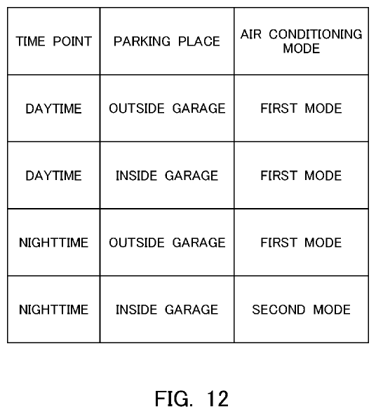

FIG. 12 is a view illustrating a relationship among time point, parking place, and air conditioning mode. This relationship is stored in the auxiliary storage unit 303. The time point and the air conditioning mode are the same as those in FIG. 5, and hence, the description thereof will be omitted. The parking place is represented by “inside garage” or “outside garage”. The “inside garage” represents that the vehicle 10 is parked in a garage with a door. On the other hand, the “outside garage” represents that the vehicle 10 is parked in a place other than a garage.

Here, in cases where the vehicle 10 is parked inside a garage, the problem of noise is unlikely to occur in the daytime, but there is a concern that the noise may reverberate in the neighborhood at night. Therefore, in cases where the parking place is outside a garage or in cases where the time point is in the daytime, the first mode is set with priority given to enhancing the performance of air conditioning over suppressing noise. On the other hand, in cases where the parking place is inside a garage and the time point is in the nighttime, the second mode is set with priority given to the suppression of noise rather than the enhancement of the performance of air conditioning.

Based on the output of the obstacle sensor 45 transmitted from the vehicle 10, the control device 110 determines that the vehicle 10 is parked in a garage in cases where obstacles are present in front and behind the vehicle 10. Here, note that, as an alternative, in cases where there are obstacles in all of diagonally forward right, diagonally forward left, diagonally rear right, and diagonally rear left, of the vehicle 10, it may be determined that the vehicle 10 is parked inside a garage. In addition, the detection value of the obstacle sensor 45 may be transmitted from the vehicle 10 to the server 30 at predetermined time intervals, or may be transmitted from the vehicle 10 to the server 30 when a request is made from the server 30 to the vehicle 10.

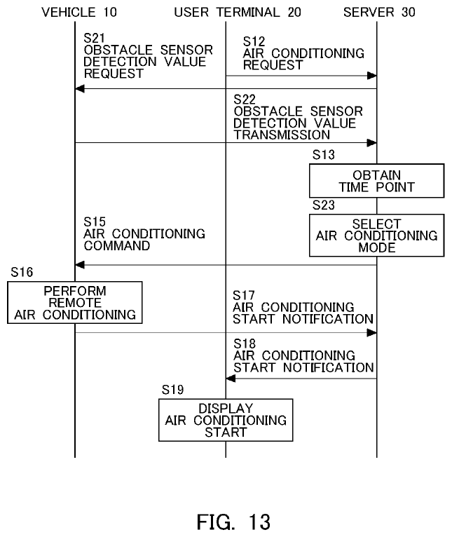

Now, the processing of the system 1 as a whole will be described. FIG. 13 is a sequence diagram of the processing of the system 1 as a whole according to the second embodiment. Here, note that the same processing as in FIG. 9 will be denoted by the same reference sign, and the description thereof will be omitted. In the processing illustrated in FIG. 13, when the server 30 receives an air conditioning request from the user terminal 20 (S12), a request (obstacle sensor detection value request) for transmitting the detection value of the obstacle sensor 45 is sent from the server 30 to the vehicle 10 (S21). In response to this command, the detection value of the obstacle sensor 45 is transmitted from the vehicle 10 to the server 30 (S22). Then, the server 30 selects the air conditioning mode based on the detection value of the obstacle sensor 45 and the time point (S23).

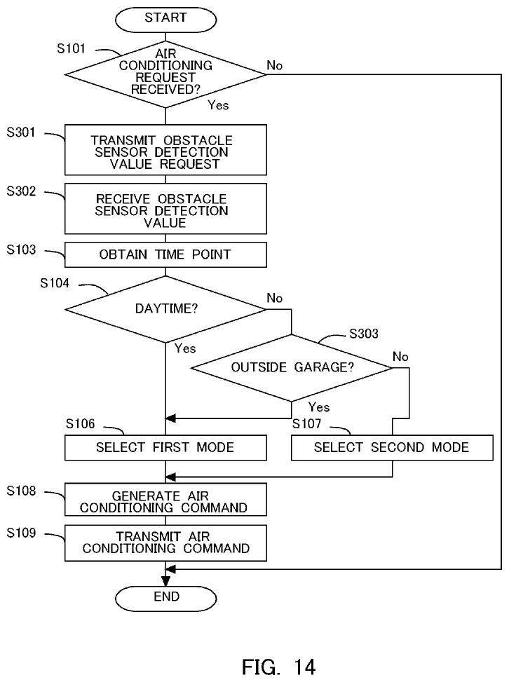

Next, the processing of the remote air conditioning in the server 30 will be described. FIG. 14 is a flowchart of the processing of the remote air conditioning in the server 30 according to the second embodiment. The processing illustrated in FIG. 14 is performed at predetermined time intervals at the server 30. Note that the steps in which the same processing is performed as in the routine illustrated in FIG. 10 are denoted by the same reference signs, and the description thereof will be omitted.

In the routine illustrated in FIG. 14, when an affirmative determination is made in step S101, the processing proceeds to step S301. In step S301, the control device 31 transmits an obstacle sensor detection value request to a vehicle 10. The control device 31 identifies a target vehicle 10 from a user ID or a vehicle ID included in the air conditioning request, and transmits a command to the target vehicle 10. The control device 110 of the vehicle 10, which has received this command, obtains the detection value of the obstacle sensor 45 and transmits it to the server 30.

In step S302, the control device 31 receives the detection value of the obstacle sensor 45 from the vehicle 10. The detection value of the obstacle sensor 45 thus received is stored in the auxiliary storage unit 303 associated with the vehicle ID.

In addition, in the routine illustrated in FIG. 14, when a negative determination is made in step S104, the processing proceeds to step S303. In step S303, the control device 31 determines whether or not the place where the vehicle 10 is parked is outside a garage. The control device 31 determines that the vehicle 10 is parked outside a garage, in cases where there is no obstacle in front of or behind the vehicle 10, based on the detection value of the obstacle sensor 45. Here, note that, as an alternative, in cases where there is no obstacle in any of diagonally forward right, diagonally forward left, diagonally rear right, and diagonally rear left, of the vehicle 10, it may be determined that the vehicle 10 is parked outside a garage. When an affirmative determination is made in step S303, the processing proceeds to step S106, whereas when a negative determination is made, the processing proceeds to step S107.

As described above, according to the second embodiment, it is possible to determine whether or not a vehicle 10 is parked in a garage, by using the detection value of the obstacle sensor 45, and to select an air conditioning mode based on the result of the determination. As a result, remote air conditioning can be operated in an appropriate air conditioning mode. Therefore, it is possible to suppress the occurrence of a noise problem.

### Third Embodiment

In the first and second embodiments, the air conditioning mode is selected based on the place and the time point at which the vehicle 10 is parked, but there may be cases where a user does not want air conditioning in the first mode due to noise concerns. On the other hand, in a third embodiment, remote air conditioning can be operated in the second mode based on a request from a user.

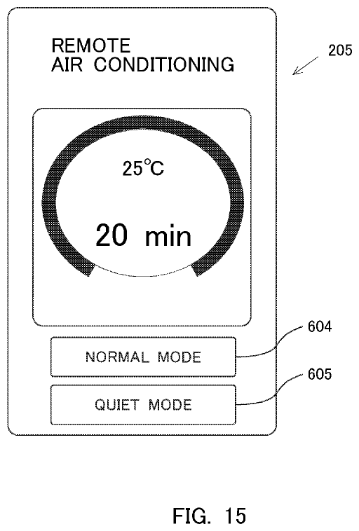

FIG. 15 is a view illustrating an example of an image displayed when an app capable of performing remote air conditioning is activated. The image is configured to include a button 604 for performing remote air conditioning in normal mode and a button 605 for performing remote air conditioning in quiet mode. The user can specify the air conditioning mode by tapping any of the buttons for either normal or quiet mode. Here, note that the normal mode is the air conditioning mode as described in the first embodiment or the second embodiment, and is a mode in which the air conditioning mode is set to the first mode or the second mode according to the place and the time point at which the vehicle 10 is parked. On the other hand, the quiet mode is a mode in which the air conditioning mode is set to the second mode regardless of the place and the time point at which the vehicle 10 is parked.

The user terminal 21 of the control device 20 obtains which of normal mode and quiet mode has been tapped by the user, and generates an air conditioning request. The air conditioning request in the present embodiment includes either a request for remote air conditioning in normal mode or a request for remote air conditioning in quiet mode. The control device 21 transmits the air conditioning request thus generated to the server 30.

In cases where the air conditioning request received includes a request for remote air conditioning in quiet mode, the server 30 generates an air conditioning command for operating the air conditioning in the second mode, and transmits it to the vehicle 10. On the other hand, in cases where the air conditioning request received includes a request for remote air conditioning in normal mode, the server 30 selects the air conditioning mode based on the place and the time point at which the vehicle 10 is parked, accordingly generates an air conditioning command, and transmits it to the vehicle 10.

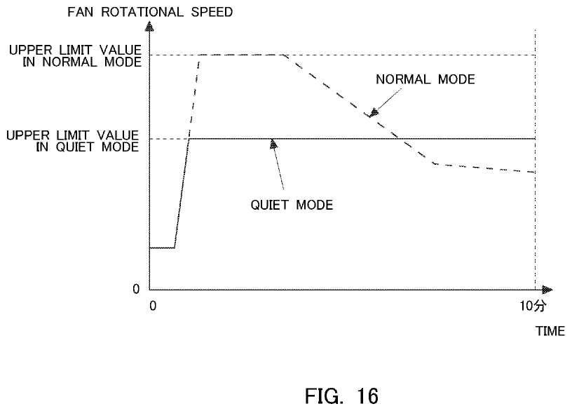

FIG. 16 is a time chart illustrating a temporal change of a fan rotational speed. The horizontal axis indicates time, and the vertical axis indicates the actual rotational speed of the fan 52. In FIG. 16, a solid line indicates the fan rotational speed when the quiet mode is selected, and the dashed line indicates the fan rotational speed when the normal mode and the first mode are selected. The remote air conditioning is operating for 10 minutes. An “upper limit value in the normal mode” in the fan rotational speed is an upper limit value of the rotational speed of the fan 52, which is set when the normal mode is selected and the first mode is selected, and an “upper limit value in the quiet mode” is an upper limit value of the rotational speed of the fan 52, which is set when the quiet mode (which may be the second mode) is selected. Thus, the upper limit value in the quiet mode is lower than the upper limit value in the normal mode. In the example illustrated in FIG. 16, when the quiet mode is selected, the vehicle interior temperature does not reach a desired temperature in 10 minutes, and hence, the fan rotational speed, when reaches the upper limit value in the quiet mode, remains as it is. That is, since the rotational speed of the engine 41 and the rotational speed of the fan 52 are kept low, the heating performance, for example, becomes apparently low, so that the vehicle interior temperature cannot be raised to the desired temperature. However, a certain degree of heating effect can be obtained unless it is in an extremely cold region.

On the other hand, when the first mode is selected at the time of normal mode, the upper limit value of the fan rotational speed is set to a relatively high upper limit value at the time of normal mode, so that the sound generated becomes louder, but for example, the heating performance can be fully exhibited, thus making it possible to quickly increase the vehicle interior temperature. Therefore, the vehicle interior temperature can be quickly raised to the desired temperature. In the example illustrated in FIG. 16, after the rotational speed of the fan 52 reaches the upper limit value, feedback control based on the vehicle interior temperature is performed, so that the number of revolutions per unit time (i.e., the rotational speed) of the fan 52 decreases.

Thus, in the quiet mode, the power consumption of the air conditioner 50 can be reduced by operating the air conditioner 50 while decreasing the upper limit value of the rotational speed of the fan 52. Therefore, the electric power, which is required to be generated by the engine 41, can be reduced, so that the rotational speed of the engine 41 can also be suppressed low. Therefore, the sound to be generated can be reduced. Although FIG. 16 illustrates the upper limit value of the rotational speed of the fan 52, the upper limit value of the rotational speed of the compressor 51 can be considered in the same way.

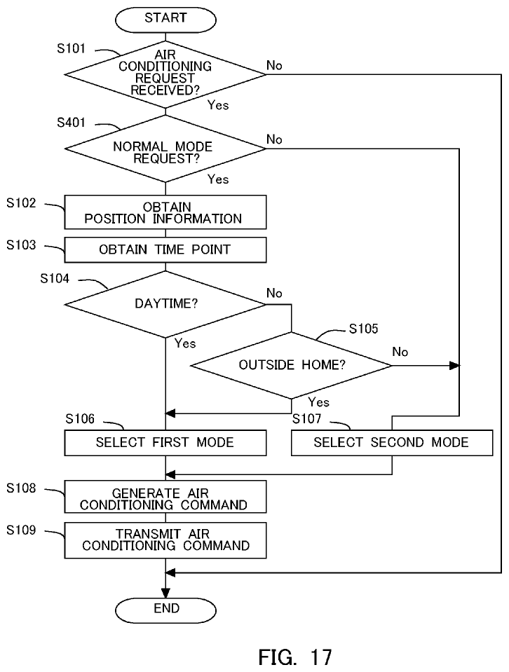

Next, the processing of the remote air conditioning in the server 30 will be described. FIG. 17 is a flowchart of the processing of the remote air conditioning in the server 30 according to the third embodiment. The processing illustrated in FIG. 17 is performed at predetermined time intervals at the server 30. Note that the steps in which the same processing is performed as in the routine illustrated in FIG. 10 are denoted by the same reference signs, and the description thereof will be omitted.

In the routine illustrated in FIG. 17, when an affirmative determination is made in step S101, the processing proceeds to step S401. In step S401, the control device 31 determines whether or not the air conditioning request includes a request to perform remote air conditioning in normal mode. When an affirmative determination is made in step S401, the processing proceeds to step S102, whereas when a negative determination is made, the processing proceeds to step S107, where the second mode is selected.

As described above, according to the present embodiment, it is possible to provide remote air conditioning that meets the needs of a user.

### Fourth Embodiment

In a fourth embodiment, the upper limit values of the rotational speeds of the compressor 51 and the fan 52 are respectively set in a third mode, which is the air conditioning mode when a user operates the air conditioner 50 inside the vehicle 10. Then, the upper limit values of the rotational speeds of the compressor 51 and the fan 52 are made higher in the first mode than in the third mode, and the upper limit values of the rotational speeds of the compressor 51 and the fan 52 are made lower in the second mode than in the third mode. Here, note that, as an alternative, the upper limit values of the rotation speeds of the compressor 51 and the fan 52 may be the same in the third mode and the second mode. As another alternative, the upper limit values of the rotational speeds of the compressor 51 and the fan 52 may be made higher in the second mode than in the third mode.

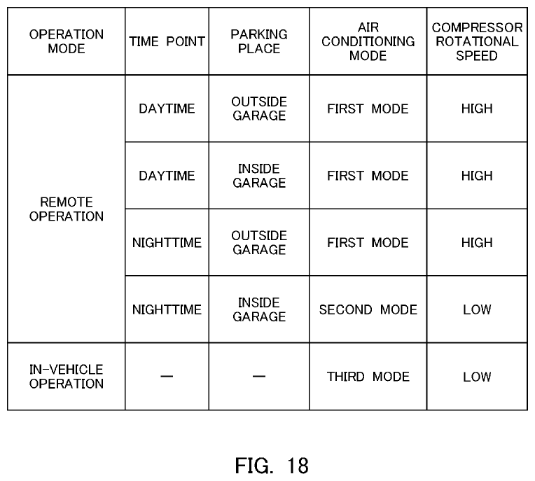

FIG. 18 is a view illustrating a relationship among operation mode, time point, parking place, and air conditioning mode. In FIG. 18, the following description will be made on the assumption that the upper limit values of the rotational speeds of the compressor 51 and the fan 52 are equal in the third mode and the second mode. This relationship is stored in the auxiliary storage unit 303. The operation mode is represented by “remote operation” or “in-vehicle operation”. The “remote operation” represents that the air conditioner 50 is operated by an air conditioning request transmitted from the user terminal 20. On the other hand, the “in-vehicle operation” represents that the user operates the control panel of the air conditioner 50 in the vehicle to activate the air conditioner 50. Here, note that the remote operation may be an operation at the time of IG-OFF (i.e., ignition is off), and the in-vehicle operation may be an operation at the time of IG-ON (i.e., ignition is on). The time point is represented by daytime or nighttime, but in the in-vehicle operation, the third mode is selected regardless of the time point, and hence, the time point does not matter. The parking place is represented by, for example, “inside home” or “outside home”, but in the in-vehicle operation, the third mode is selected regardless of the parking place, and hence, the parking place does not matter.

The air conditioning mode is represented by the first mode, the second mode, or the third mode. The first mode is a mode in which the upper limit values of the rotational speeds of the compressor 51 and the fan 52 are relatively high. The second mode is a mode in which the upper limit values of the rotational speeds of the compressor 51 and the fan 52 are relatively low. The upper limit values of the rotational speeds of the compressor 51 and the fan 52 are set to be lower in the second mode than in the first mode. The third mode is a mode in which the upper limit values of the rotational speeds of the compressor 51 and the fan 52 are relatively low. The upper limit values of the rotational speeds of the compressor 51 and the fan 52 are set to be lower in the third mode than in the first mode.

Here, in cases where the remote air conditioning is operated in the first mode, it is unlikely to be a problem even if a relatively loud sound is generated, since the user is not in the vehicle 10. On the other hand, if the user is riding in the vehicle 10, the user may feel uncomfortable if the sound generated by the operation of the air conditioner 50 is too loud. Therefore, the third mode can suppress the user from feeling uncomfortable, by lowering the upper limit values of the rotational speeds of the compressor 51 and the fan 52 compared to the first mode. Therefore, the upper limit values of the rotational speeds of the compressor 51 and the fan 52 in the third mode may be set so that the noise vibration (NV) is within an allowable range. Here, note that the upper limit value of the rotational speed of a blower fan of the air conditioner 50 arranged in the vehicle may be set in the same manner as the upper limit values of the rotational speeds of the compressor 51 and the fan 52. That is, in the third mode, the upper limit value of the rotational speed of the blower fan may be made lower than in the first mode.

In addition, in cases where the remote air conditioning is operated in the second mode, there is no user in the vehicle 10, but noise may be a problem outside the vehicle 10. Therefore, the second mode may be set such that the upper limit values of the rotational speeds of the compressor 51 and the fan 52 are lower than those in the third mode.

Here, note that the third mode is selected when the user operates the control panel of the air conditioner 50 in the vehicle, and hence, the control device 110 operates the air conditioner 50 in the third mode. In this case, even if there is no command from the server 30, the control device 110 operates the air conditioner 50 in the third mode.

As described above, according to the present embodiment, in the first mode, the upper limit values of the rotational speeds of the compressor 51 and the fan 52 are higher than those in the third mode, thus making it possible to adjust the temperature inside the vehicle more quickly. Then, in cases where the air conditioner 50 is operated in the first mode, the problem of noise is unlikely to occur. Also, in the second mode, the upper limit values of the rotational speeds of the compressor 51 and the fan 52 are relatively low, which can suppress the problem of noise from occurring. In addition, in the third mode, the upper limit values of the rotational speeds of the compressor 51 and the fan 52 are suppressed, thus making it possible to suppress the user in the vehicle from feeling uncomfortable.

### Other Embodiments

The above-described embodiments are merely examples, but the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the vehicle 10 may have a part or all of the functions of the server 30.

In addition, in the above embodiments, the time of day is divided into two time zones, daytime and nighttime, for each of which the air conditioning mode is set, but the time of day can be divided into three time zones, for example, morning, noon, and night. Then, the upper limit values of the rotational speeds of the compressor 51 and the fan 52 may be set based on the tolerance of sound in each time zone.

Moreover, in the first embodiment, in cases where the vehicle 10 is parked at home and the time point is in the nighttime, the second mode is selected to avoid disturbing the neighbors. On the one hand, even in cases where the vehicle 10 is parked outside home, e.g., in cases where the vehicle 10 is parked in a residential area, noise may become a problem. On the other hand, the problem of noise is less likely to occur in originally noisy places such as downtown areas, or places where there are no houses around, such as riverbeds or the like. Therefore, for example, map information is stored in the auxiliary storage unit 303 of the server 30, and compared with the position information of the vehicle 10, if the vehicle 10 is parked in a residential area and the time point is in the nighttime, the second mode may be selected, and the first mode may be selected in other cases.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to perform:
obtaining information about a place where a vehicle is parked in response to receiving a request to remotely operate air conditioning;
obtaining information about a time point;
selecting an air conditioning mode for the vehicle based on the information about the place and the information about the time point; and
transmitting to the vehicle a command to operate the air conditioning in the air conditioning mode thus selected.

2. The information processing apparatus according to claim 1, wherein
the air conditioning mode includes a first mode and a second mode in which an upper limit value of a rotational speed of a compressor or an upper limit value of a rotational speed of a fan for the air conditioning is lower than that in the first mode.

3. The information processing apparatus according to claim 2, wherein
the controller is configured to perform:
obtaining, as the information about the place, information that can determine whether or not the place is a garage; and
selecting the first mode in cases where the place where the vehicle is parked is a place other than the garage.

4. The information processing apparatus according to claim 2, wherein
the controller is configured to perform:
obtaining, as the information about the place, information that can determine whether or not the place is a garage;
selecting the first mode in cases where the place where the vehicle is parked is the garage and where the time point is within a first time zone including noon; and
selecting the second mode in cases where the place where the vehicle is parked is the garage and where the time point is within a second time zone that does not include the first time zone but includes 0:00 a.m.

5. The information processing apparatus according to claim 3, wherein
the controller is configured to perform:
obtaining, as the information about the place, information about a detection value of an obstacle sensor provided in the vehicle;
determining that the place where the vehicle is parked is the garage, in cases where obstacles are detected by the obstacle sensor in front of and behind the vehicle; and
determining that the place where the vehicle is parked is other than the garage, in cases where no obstacle is detected in front of or behind the vehicle.

6. The information processing apparatus according to claim 2, wherein
the controller is configured to perform:
obtaining, as the information about the place, information that can determine whether or not the place is a home of a user of the vehicle; and
selecting the first mode in cases where the place where the vehicle is parked is other than the home.

7. The information processing apparatus according to claim 2, wherein
the controller is configured to perform:
obtaining, as the information about the place, information that can determine whether or not the place is a home of a user of the vehicle;
selecting the first mode in cases where the place where the vehicle is parked is the home and where the time point is within a first time zone including noon; and
selecting the second mode in cases where the place where the vehicle is parked is the home and where the time point is within a second time zone that does not include the first time zone but includes 0:00 a.m.

8. The information processing apparatus according to claim 6, further comprising:
a memory configured to store information about a position of the home of the user of the vehicle; wherein
the controller is configured to perform:
obtaining, as the information about the place, information about a position of the vehicle; and
determining whether or not the place where the vehicle is parked is the home of the user, by comparing the information about the position of the home of the user of the vehicle stored in the memory with the information about the position of the vehicle.

9. The information processing apparatus according to claim 2, wherein
the first mode is higher, in the upper limit value of the rotational speed of the compressor or the upper limit value of the rotational speed of the fan for the air conditioning, than a mode which is a third mode in the case where the user of the vehicle operates the air conditioning in the vehicle.

10. The information processing apparatus according to claim 2, wherein
the second mode is lower, in the upper limit value of the rotational speed of the compressor or the upper limit value of the rotational speed of the fan for the air conditioning, than a mode which is a third mode in the case where the user of the vehicle operates the air conditioning in the vehicle.

11. The information processing apparatus according to claim 2, wherein
the second mode is equal, in the upper limit value of the rotational speed of the compressor or the upper limit value of the rotational speed of the fan for the air conditioning, to a mode which is a third mode in the case where the user of the vehicle operates the air conditioning in the vehicle.

12. The information processing apparatus according to claim 2, wherein
the controller is configured to perform:
selecting the second mode as the air conditioning mode, regardless of the information about the place and the information about the time point, in cases where a request to remotely operate the air conditioning in the vehicle and to operate the air conditioning in the second mode has been received from a terminal of a user of the vehicle.

13. An information processing method for causing a computer to perform:
obtaining, in response to receiving a request to remotely operate air conditioning in a vehicle, information about a place where the vehicle is parked;
obtaining information about a time point;
selecting an air conditioning mode for the vehicle based on the information about the place and the information about the time point; and
transmitting to the vehicle a command to operate the air conditioning in the air conditioning mode thus selected.

14. The information processing method according to claim 13, wherein
the air conditioning mode includes a first mode and a second mode in which an upper limit value of a rotational speed of a compressor or an upper limit value of a rotational speed of a fan for the air conditioning is lower than that in the first mode.

15. The information processing method according to claim 14, wherein
the computer is configured to perform:
obtaining, as the information about the place, information that can determine whether or not the place is a garage; and
selecting the first mode in cases where the place where the vehicle is parked is a place other than the garage.

16. The information processing method according to claim 14, wherein
the computer is configured to perform:
obtaining, as the information about the place, information that can determine whether or not the place is a garage;
selecting the first mode in cases where the place where the vehicle is parked is the garage and where the time point is within a first time zone including noon; and
selecting the second mode in cases where the place where the vehicle is parked is the garage and where the time point is within a second time zone that does not include the first time zone but includes 0:00 a.m.

17. The information processing method according to claim 15, wherein
the computer is configured to perform:
obtaining, as the information about the place, information about a detection value of an obstacle sensor provided in the vehicle;
determining that the place where the vehicle is parked is the garage, in cases where obstacles are detected by the obstacle sensor in front of and behind the vehicle; and
determining that the place where the vehicle is parked is other than the garage, in cases where no obstacle is detected in front of or behind the vehicle.

18. The information processing method according to claim 14, wherein
the computer is configured to perform:
obtaining, as the information about the place, information that can determine whether or not the place is a home of a user of the vehicle; and
selecting the first mode in cases where the place where the vehicle is parked is other than the home.

19. The information processing method according to claim 14, wherein
the computer is configured to perform:
obtaining, as the information about the place, information that can determine whether or not the place is a home of a user of the vehicle;
selecting the first mode in cases where the place where the vehicle is parked is the home and where the time point is within a first time zone including noon; and
selecting the second mode in cases where the place where the vehicle is parked is the home and where the time point is within a second time zone that does not include the first time zone but includes 0:00 a.m.

20. The information processing method according to claim 18, wherein
the computer is configured to perform:
obtaining, as the information about the place, information about a position of the vehicle; and
determining whether or not the place where the vehicle is parked is the home of the user, by comparing the information about the position of the home of the user of the vehicle stored in a memory with the information about the position of the vehicle.
